(19) United States
(12) Patent Application Publication
(10) Pub. No.: US 2010/0051778 A1
(43) Pub. Date: Mar. 4, 2010

(54) Controlled Space with Anti-Shock Function for Automotive Electronics

(76) Inventor: Albert Taan Wu, Paramus, NJ (US)

Correspondence Address: KATHERINE BRADY, 110 E. 57TH ST. #10F, New York, NY, 10022, US

(21) Appl. No.: 12/203,147

(22) Filed: Sep. 3, 2008

(51) Int. Cl. F16M 13/00

(52) U.S. Cl. 248/562; 280/728.1

(57) ABSTRACT

The invention described is a controlled environment designed to house automotive onboard electronics. In general, the vibration and impact a moving vehicle experiences is detrimental to certain electronic components such as hard disk drives. Only the high-end automobiles that are equipped with elaborated shock absorbing devices may provide a suitable operating environment for these delicate electronics. Based on a completely different approach, this invention is to create a controlled space with a novel apparatus to reduce the shock and vibration within its domain regardless of what the automobile experiences. Therefore, the electronic components that reside inside this controlled space will experience far less severe impact thus enhance their chance of survival.

### SUMMARY

The first objective of this invention is to create a controlled space in the interior of an automobile. This controlled space is embodied with an anti-shock apparatus such that it is mounted onto the automobile frame and yet, as far as the vibration is concerned, it is mechanically isolated from the frame as remote as possible. The condition within this controlled space shall provide any resident electronic device near-isolation from both internal and external vibration sources so long as the vehicle is operating under normal design condition.

The second objective of this invention is to have the aforementioned apparatus be a passive mechanical device. In other words, this apparatus shall function reasonably well by itself with or without being aided or controlled by an intelligent device such a CPU.

The third objective of this invention is to fit this apparatus in a compact space such that it can be mounted either inside the trunk or the passenger compartment. In this case, it will provide the shock isolation necessary for the onboard electronics without intruding on the interior design of the automobile.

This invention is to introduce a novel apparatus which is capable of isolating the shock and vibration substantially via mechanical means. This will protect the electronic devices that reside inside this controlled domain from being damaged by the excessive shock generated by the road condition and transmitted through car frame.

### BRIEF DESCRIPTION OF THE FIGURES

FIG. 1 describes the exterior container 1

FIG. 2 describes the interior container 2

FIG. 3 is the exploded drawing to show how this apparatus shall be assembled

### DESCRIPTION OF PREFERRED EMBODIMENT

The invention described below may be realized in various embodiments. Since it is not practical to cover all the variations, the present disclosure is intended to provide examples of the principles of the invention and not intended to limit the invention to the specific embodiments displayed and described. In the description below, reference numerals are used to add clarity to the description.

This invention starts with the following well-known formula covering force and motion, including vibration, in the field of “Dynamics”.

f(t)=m*(d²x/dt²)+η*(dx/dt)+k*x

whereas: m is the mass of the object under protection, a constant
η is the damping coefficient of the environment, a constant
k is the spring constant of the environment, a constant
x is the position vector of the object, a time function
dx/dt is the velocity vector of the object, a time function
d²x/dt² is the acceleration vector of the object, a time function
f is the summation of the external force vectors applied to the system, a time function

The objective of this invention is to minimize the acceleration vector asserted onto the object under protection throughout the entire operation time span. Theoretically there are several ways to achieve this goal. Among them:
1. The first method is to increase the mass m of the object to infinite. This will obviously reduce the acceleration d²x/dt² to zero. Although infinite mass m is not practical, this does point to a direction that increasing the mass can reduce the acceleration, thus the magnitude of vibration.
2. The second method is to isolate the external force f from the object. However, in the earth gravitational field g, an object of mass m carries a weight w, which is equivalent to m*g. It will need support to hold the object in a relatively stable position in the gravitational field.
   If the support is in the form of rigid structure, then unfortunately the external forces can and will pass through it to cause acceleration of vibration on the object. A new method of support, instead of rigid structure, is obviously necessary to prevent this from happening.
   The choice is to use buoyancy B to counter the weight w. The formulae are:

w=m*g

B=ρ*V

Whereas: w is the weight of the object under protection
m is the mass of the object under protection
g is the earth gravity (9.8 m/sec²)
B is the buoyancy the object under protection experienced
ρ is the density of the fluid exterior to the object (including packaging material)
V is the volume of the object (including packaging material)
When the proper design leads to B≈w, the object is nearly floating in the space surrounded by the fluid of density ρ. This eliminates the necessity of rigid supporting structure, thus the opportunity to let the external force being substantially transmitted to the object.

The embodiment described in the following represents a practical and physical realization of the second method.

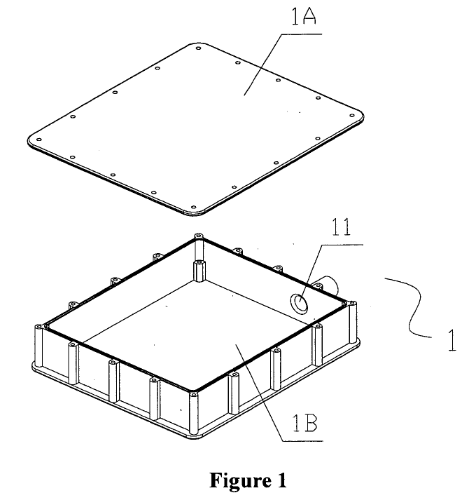

FIG. 1 describes the exterior container 1. It consists of a container body 1B and a lid 1A. On a wall of the container body 1B, there is a watertight outlet 11 to let the electric cable of plural number of wires to pass through. When the lid 1A is installed onto the body 1B, together they will form a water tight container 1.

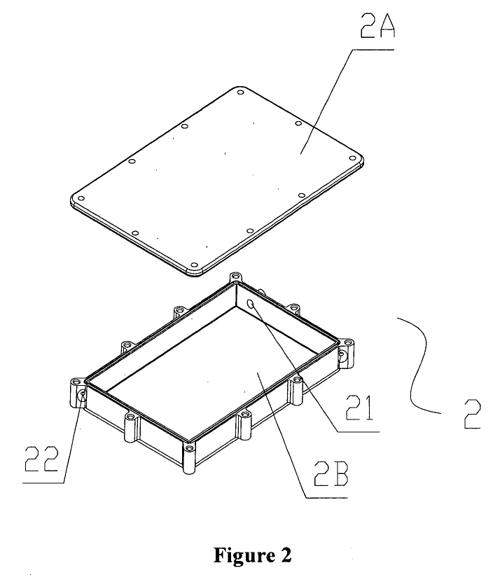

FIG. 2 describes the interior container 2. It consists of a container body 2B and a lid 2A. On a wall of the container body 2B, there is a watertight outlet 21 to let the electric cable of a plural number of wires to pass through. On the exterior corners, there are mounting lugs 22 which are designed to allow weak springs being attached to them to provide additional support when needed. When the lid 2A is installed onto the body 2B, together they will form a water tight container 2.

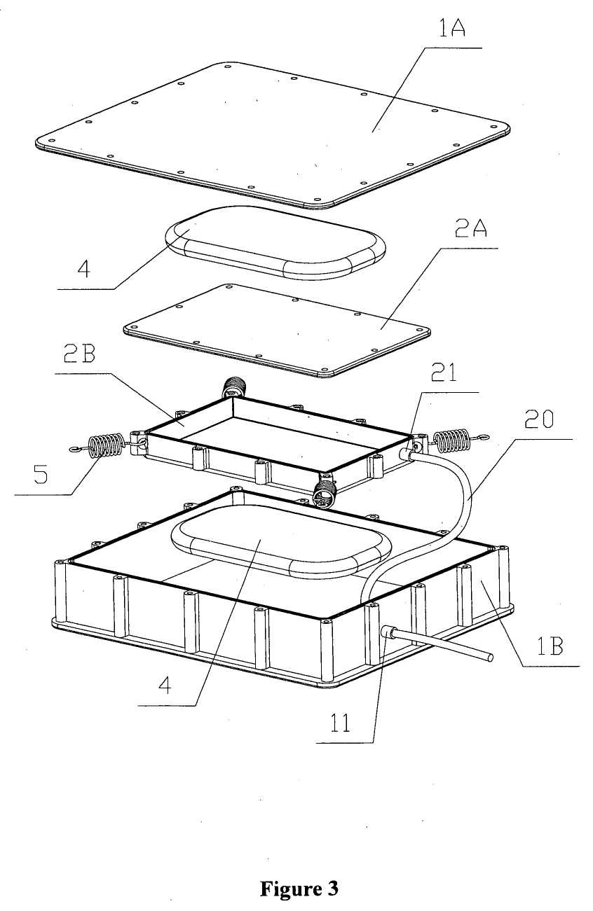

FIG. 3 is the exploded drawing to show how this apparatus shall be assembled. First the target of protection, presumably a hard disc drive (HDD), shall be installed inside the body 2B of the interior container 2, with the electrical connection cable passing through the watertight outlet 21. Depending on material, the exterior portion of this cable can be cable 20, as shown. When the lid 2A is closed, the HDD will be water tightly sealed in the interior container 2.

The interior container 2 will then be installed inside the exterior container 1 with the springs 5 attached to the lugs at the interior corners of the container 1. The cable 20 will pass through the watertight outlet 11 to connect to another external device not shown. When the lid 1A is closed, it will form the exterior water tight container 1.

Fluid of proper density will be filled into the space between the interior container 2 and the exterior container 1. This is to provide appropriate amount of buoyancy to let the interior container 2 (with its payload HDD) to flow freely. The optional air bags 4 are designed to add buoyancy to the interior container 2, when needed.

The springs 5 are necessary to help restore the nominal position of the interior container 2, while the exterior container 1 is under constant vibration.

What is claimed is:

1. A shock reducing apparatus, for automotive electronic devices, which consists of a first liquid tight containing vessel and a smaller second liquid tight containing vessel, such that the to-be protected electronics resides inside the said second containing vessel while it resides inside the said first containing vessel and the space in between of the said first and second containing vessels is filled with fluid of appropriate density and viscosity to provide proper buoyancy.

2. In a shock reducing apparatus of claim 1, both the said containing vessels have at least one liquid tight outlet such that the electronic connection cable of the to-be-protected electronics can pass through the said outlet in a liquid tight fashion to reach the exterior of the said second containing vessel and routing loosely in the fluid to pass the said liquid tight outlet of the said first containing vessel into the exterior of it.

3. In a shock reducing apparatus of claim 2, there may be springs of appropriate spring constant mechanically connecting the exterior of the said smaller second containing vessel to the interior of the said first containing vessel, such that the springs are relatively relaxed in conjunction with the buoyancy while the said containing vessels are maintained in the nominal position.

4. In an automobile shock reducing apparatus of claim 3, airbag type floatation devices maybe attached to the sides of the said second containing vessel to provide extra buoyancy in order to give additional measures for proper matching in between of the mass and the volume of to-be-protected device(s), the spring constant and the density of the fluid.
